(19) United States
(12) Patent Application Publication
(10) Pub. No.: US 2006/0234200 A1
(43) Pub. Date: Oct. 19, 2006

(54) Computer based method for self-learning and auto-certification

(76) Inventor: Alain Rochedy, Parc du Gullon Coubelevie (FR)

Correspondence Address: Donald J. Ersler, 725 Garvens Avenue, Brookfield, WI, 53005, US

(21) Appl. No.: 11/392,082

(22) Filed: Mar. 29, 2006

(30) Foreign Application Priority Data
Apr. 18, 2005 (FR) 05 03841

(51) Int. Cl. G09B 7/00

(52) U.S. Cl. 434/323; 434/362

(57) ABSTRACT

A computer based method for self-learning and auto-certification includes a plurality of quizzes and a review routine. The student begins by taking a quiz. Each quiz includes a plurality of presentations concerning a particular topic area. Each presentation is followed by a question. The question is followed by multiple potential answers. If the student passes the quiz they continue to the next quiz. If the student fails the quiz they retake the quiz. When the student passes all the quizzes, they advance to the review routine. Questions are randomly selected from all the previous quizzes in the review routine. The review routine presents the selected questions and stores the student answers. If the student fails some quizzes after the review routine, the student goes back to retaking the failed quizzes.

### BACKGROUND OF THE INVENTION

1. Field of the Invention

The present invention relates generally to automated interactive training systems and methods and more specifically to a computer based method for self-learning and auto-certification, which uses questions from previously passed quizzes to verify learning.

2. Discussion of the Prior Art

Training software applications can be divided in two important groups “computer based training” and “certification” applications.

In both cases, applications can be run in a stand alone local computer or in client/server groups of computers. Using an internet browser to access a web server running these types of applications is very common. An internet browser allows multimedia accesses to the central application.

Certification applications are typically based on quizzes having random questions. The questions are randomly extracted from a large stock of questions to avoid cheating. Questions can be random, the question order is not relevant, because the questions are not supposed to explain something to the end user. The objective of the questions is to check the overall current knowledge of the applicant. Random questions are well suited for checking the knowledge of the applicant. Microsoft Corporation uses certification oriented tools to test Microsoft Certified Product (MCP) and Microsoft Certified System Administrator (MCSA).

Accordingly, one or several quizzes must be passed before getting the MCP/MCSA graduation. All the quizzes are independent from each other. They can be passed in an order by the candidate. Traditional computer based training is arranged in a documentation part and in a knowledge verification part. The documentation part contains the needed information to teach the user, while the verification part is based on questions and quizzes. The documentation is usually structured in chapters and pages. The documentation includes texts, figures and photos, or multimedia records.

The knowledge verification process utilizes questions or quizzes. Quizzes can be related to a chapter, or to the entire training. Questions and quizzes can be included in the text of a chapter, at the end of each chapter, or grouped at the end of the document. Displayed questions can be the same or can change between passes. The information to be learned is presented in a separate document from the questions, which allows the questions related to a chapter to be displayed in random order. There are no learning progression constraints in the way the questions are submitted. Questions can also be different in successive occurrences of the same quiz.

The answer to a question can be Yes/No, boxes to check, or filling-in predefined keywords. Very often the user must select their answer from a list of possible answers. Quizzes may be coupled to each other. The quizzes may or may not be run in a predefined order. Failing a quiz may or may not allow the access to the next quiz. If the quizzes are independent, the order to run them is not an issue. Quizzes can be defined at the level of each chapter or they can be global to a subject including several chapters. Usually, global quizzes are independent from the individual quizzes defined at the chapter's level, because they are provided to get an evaluation of the final global user's level of proficiency, while an individual quiz is to check an intermediate knowledge.

When global quizzes and individual quizzes are coupled, several cases are possible. In a first case, the only link between the global quiz and the chapter's quizzes are the questions. A global quiz uses questions from the chapter's quizzes. Failing a global quiz has no action on an individual quiz. In the second case, questions of the global quiz are from the individual quizzes and questions are grouped per source. Even if individual quizzes are not affected by a global quiz failure, grouping the questions per source allows underlining, which area, topic, or chapter must be reviewed.

In a third case, even if this case is not implemented in reality, it must be presented because it is a logical extension of the previous case. Failing a global quiz may also oblige passing a chapter oriented quiz. The failure of a specific quiz is calculated on the few questions related to the chapter. The failure is never calculated on the global quiz questions combined to the former results of the specific quizzes. The link between global and chapter quizzes is unidirectional. Failure to answer questions in the global quiz can fail a specific test, but the user's result to a final quiz is not dependant to his former results to individual quizzes. The global and chapters quizzes use different tables to calculate their results and they are not really tightly unified. The present invention does not use any final quiz.

Accordingly, there is a clearly felt need in the art for a computer based method for self-learning and auto-certification, which uses questions from previously passed quizzes to verify learning.

### SUMMARY OF THE INVENTION

The present invention provides a computer based method for self-learning and auto certification. The computer based method allows reaching the objectives of self-learning and of auto-certification in the same session. The computer based method combines self-learning and auto-certification oriented procedures in a loop. The learning progression phase uses ordered quizzes and questions, while the auto-certification is based on the same questions presented randomly.

Results to progressive questions and quizzes are modified by new answers to the same questions presented randomly in a review final phase. The learning progression and the review phase being included in a loop of software routines. The self-learning procedure uses a predefined list of quizzes arranged in a logical learning order. Quizzes must be passed one after the other, on success of the previous one, in a chronological order. The order of the quizzes and the list of questions in a given quiz cannot be random. The questions are arranged according to a learning logical progression. All important items of the subject to be learned must be covered in a quiz or through questions of several quizzes. Including information in the questions allows bypassing extra documentation to be studied before running the quiz. Presenting quizzes and questions in a predefined order according to a learning progression has the drawback of making cheating easier and making efficient results more difficult to verify.

Random questions will be enough to check the gained knowledge over a presented subject, if they cover all the presented items. In the case of the presented method and for a perfect auto-certification, the amount of random questions must be the same as the sum of all the questions of all the quizzes of the learning progression, which is not efficient and can be boring for the end user. The solution to the above is at the end of the learning progression to randomly select questions from the quizzes; then submit randomly selected questions to the user and to reinsert the new answers in a relevant individual quiz then verify the results of the user for each quiz. Doing the above links the final and global remaining user's knowledge at the time of the review, with their understanding of each chapter at the time of their learning progression.

Failed quizzes will represent knowledge not completely understood during the learning phase and/or forgotten, while answering the final random questions. Re-injecting the review answers into the same quiz database tables allows the detection of all marginally passed quizzes and the detection of all the topics not fully remembered. The method automatically evaluates the combined current user level at the final time of the training and the user understanding at the time of the learning progression phase. After a review, failing quizzes must be passed again. The sequence of quizzes must be successful passed again, before a new review can be run. Training will be finished, and the user level will be assumed correct, when a sequence of quizzes are successful answered after a review.

An automatic loop and learning progression/review reflects a pedagogical approach: see and analyze, learn, try, correct the mistakes and improve the level by using repetitions and by learning from the errors. The presented training method is well suited for self-training. The users can utilize the method by accessing an application installed in a stand alone computer, in a server of a local private network, or in a web server. The application is designed to provide straightforward documentation.

The documentation can be used in the training phase or even later as field support documentation. Passed quizzes can always be consulted. The consultation is allowed at completion of the course or while progressing through the quizzes. Only the successfully passed quizzes can be consulted. In consult mode texts, figures, and other documents related to questions and answers are fully accessible. The consultation can be done, while running the questions of a quiz successively or through a “Content.” The content lists all the questions of the quizzes. It allows a direct access to any questions and any answers of a passed quiz. In consult mode the user cannot modify his former answers to a quiz.

In the presented method the user never passes, fails, or succeeds a global quiz. All the quizzes are attached to a specific chapter, there is no global quiz. A review is a software routine (not a quiz) just forcing the user to again pass some randomly selected questions of each quiz. Progressive questions at the time of the learning phase, and random questions at the time of the review are from the same source and use the same tables to store the answers. The same evaluation routine is applied to the same quizzes, user progressing in the learning or after the user has finished a review.

At the end of the training procedure, when a user has successfully completed a loop quiz/review, the user's final knowledge can be evaluated. The training evaluation cannot be easily summarized to one global score. The final evaluated user's level is an amalgamation of levels measured in different manners and at different times. The evaluation indirectly includes not only the scores of each quiz measured at the learning progression phase and modified at the time of the review, but also the number of times a quiz has been passed, the time spent on each quiz and the number of loops to complete the training.

The review system allows measuring the user levels after a quiz and at the end of a training progression. Even if the same verification routine is used to measure the results of a quiz in a progression phase and after the review, the results have different meanings. The purpose of a quiz is measure the instant understanding of ideas and techniques presented in a chapter. The random questions extracted by the review from the progressive quizzes have the purpose of measuring the average learned information related to each quiz topic at the end of training.

The method randomly extracts a few questions from previously passed quizzes, which forces the student to use their memory and to improve their memory. For example, “What have I already answered to this question?” The memorization effect is obtained without overloading the student by too many questions. Long and boring question analysis is also avoided, because questions are not new questions. Review questions have been seen, before the time of an individual quiz. The method is based on the repetitive principle, which is to repeat the same topic several times to understand and remember it. The goal is to provide a procedure, which is not boring or not overloaded by repetition, but still efficient to check knowledge spread over a wide range of presented information.

A student using the presented method will never say, “I have failed a review,” but he will say, “I had to again pass some quizzes after the review” or “I had to pass the review twice before succeeding all the quizzes.” The last statement means that the student in the first review failed a few quizzes. The student had to pass the unsuccessful quizzes to access a new review. The student taking the second review did not fail any quiz of the sequence. For each quiz, the student did not provide enough incorrect answers to annul the margin of good answers the student had for each quiz, before taking the review. The student passed his certification because the sequence of quizzes was still good, after a review. At the end of the measured level indirectly and through combined results of several individual quizzes, the review reflects the gained global knowledge of the student.

The invented computer based training method combines teaching objectives plus verifications objectives, which are illustrated in a software flow chart. The flow chart combines progressive quizzes, including progressive questions for learning, and random global challenges for verifications. The verification process extracts a few random questions from the progressive quizzes and re-injects the answers in the original tables, before a standard per quiz evaluation is run.

Accordingly, it is an object of the present invention to provide a computer based method for self-learning and auto-certification, which allows reaching objectives in the same session.

It is a further object of the present invention to provide a computer based method for self-learning and auto-certification, which is implemented in a single loop.

It is yet a further object of the present invention to provide a computer based method for self-learning and auto-certification, which includes a learning progression phase with ordered quizzes.

Finally, it is another object of the present invention to provide a computer based method for self-learning and auto-certification, which is based on the same questions presented randomly.

These and additional objects, advantages, features and benefits of the present invention will become apparent from the following specification.

### BRIEF DESCRIPTION OF THE DRAWINGS

FIG. 1 is a flow chart of a computer based method for self-learning and auto-certification in accordance with the present invention.

FIG. 2 is a presentation of a particular topic area with a question and multiple potential answers of a computer based method for self-learning and auto-certification in accordance with the present invention.

FIG. 3 is a graphic representation illustrating a presentation of a computer based method for self-learning and auto-certification in accordance with the present invention.

### DETAILED DESCRIPTION OF THE PREFERRED EMBODIMENTS

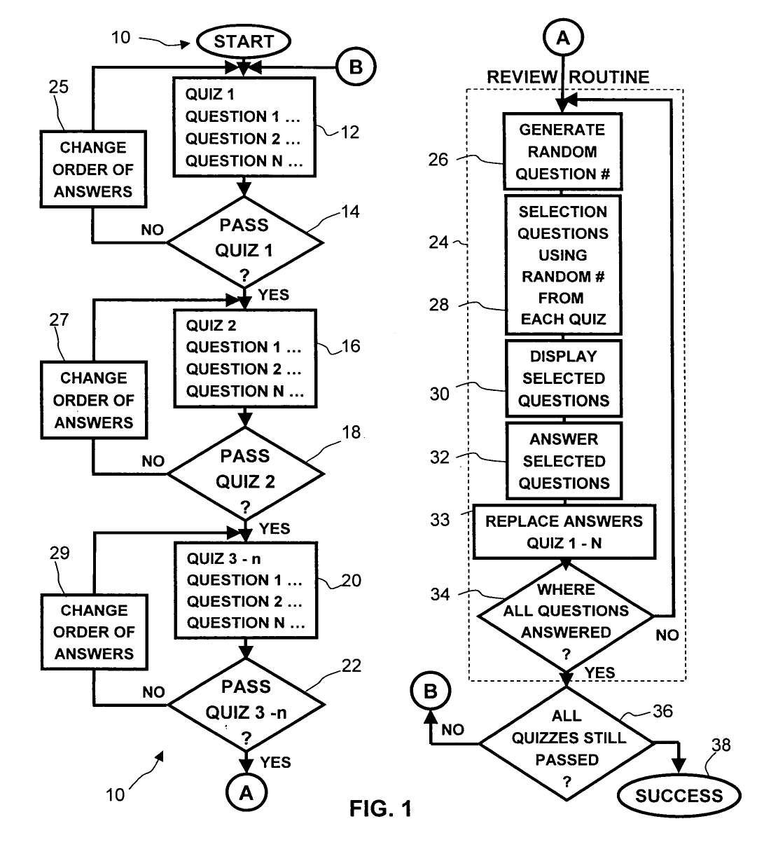

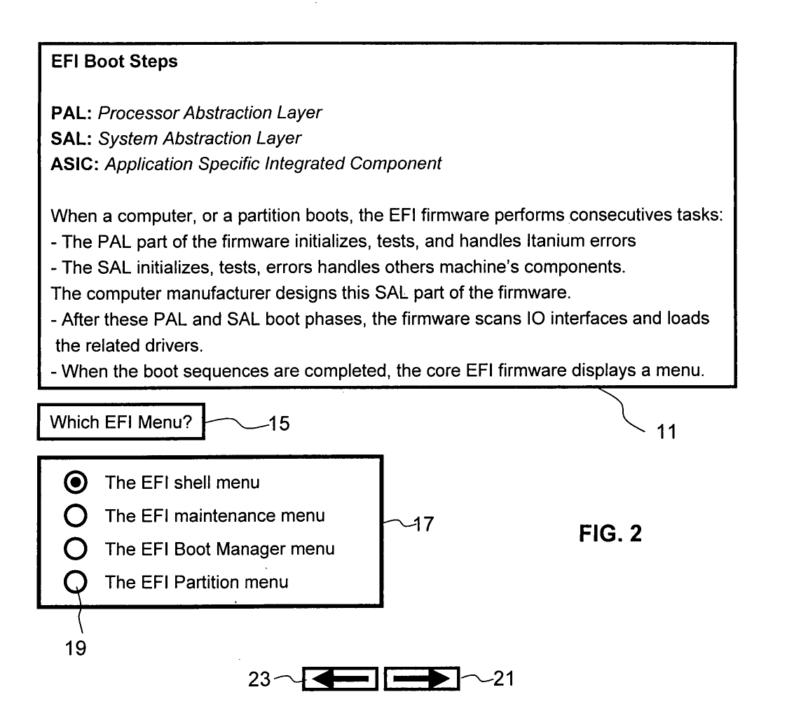

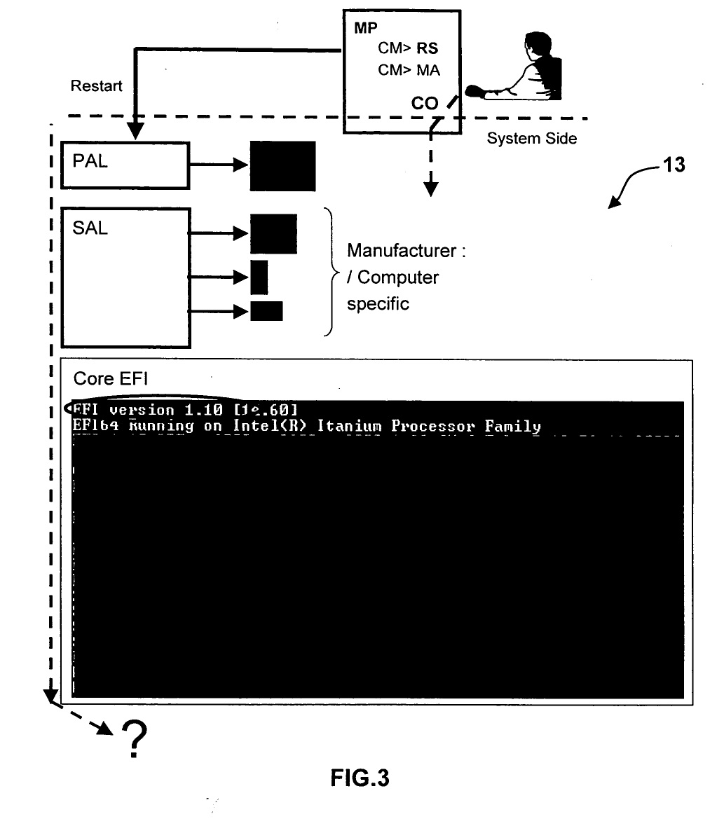

With reference now to FIG. 1, there is shown a flow chart 10 of a computer based method for self-learning and auto-certification. A user begins by taking Quiz 1 in process block 12. With reference to FIGS. 2-3, each quiz includes a presentation 11 concerning a particular topic area. The presentation 11 includes text and preferably a graphical representation 13 of information found in the text. The presentation 11 is followed by a question 15. The question 15 is followed by multiple potential answers 17. The question asks for at least one correct answer. After the student has indicated the at least one correct answer by clicking on one of the circles 19, they click on the button 21 to advance to the next presentation or the button 23 to go back to a previous presentation. Each quiz includes a plurality of presentations.

Referring briefly to the flow chart 10, process block 12 includes Quiz 1. Quiz 1 includes questions 1-n. The questions are arranged in a predetermined order according to a particular learning progression defined by some official. In decision block 14, if the number of questions answered correctly is greater than a defined minimum number, Quiz 1 is passed. Quiz 2 becomes accessible in process block 14 and the user opens and runs Quiz 2. If the user fails Quiz 1, they must retake Quiz 1, until they pass Quiz 1. The order of the answers in Quiz 1 are changed in process block 25 from that originally presented. Changing the order of the answers, makes it more difficult to cheat on Quiz 1.

The student takes Quiz 2 in process block 16. Quiz 2 includes questions 1-n. The questions are arranged in a predetermined order according to a particular learning progression defined by some official. In decision block 18, if the number of questions answered is greater than a defined minimum number; Quiz 2 is passed Quiz 3-n becomes accessible and the student opens and runs Quiz 3-n. If the student fails Quiz 2, they must retake Quiz 2, until they pass Quiz 2. The order of the answers in Quiz 2 are changed in process block 27 from that originally presented.

The student takes the remaining Quizzes 3-n in process block 20. The remaining Quizzes 3-n each include questions 1-n. The questions are again arranged in a predetermined order according to a particular learning progression defined by some official. In decision block 22, if the student passes Quizzes 3-n, they continue to a review routine 24. If the student fails any one of Quizzes 3-n, they must retake the Quiz, until they pass the Quiz. The order of the answers in any one of the Quizzes 3-n are changed in process block 29 from that originally presented.

The review routine 24 is started in process block 26 by generating a random number. The random number is used to randomly select at least one question from all the quizzes 1-n in process block 28. The selected questions are displayed one after another in process block 30. For each question, the student selects at least one correct answer from the presented list of potential answers in process block 32. The process blocks 30 and 32 are linked in a question/answer loop. The review routine 24 is exited when all the questions are answered in decision block 34.

The answers to the selected questions in the review routine 24 replace the previous answers to the quizzes 1-n in process block 33. At the completion of the review routine, the scores to the quizzes 1-n are recalculated. If all the quizzes 1-n remain passed, after the review routine 24, then the student is finished with the training in decision 36. The student is presented with a congratulatory message in process block 38. If the student did not pass all the quizzes, they must retake the quizzes they failed. The student may have to loop through the flow chart 10 several times, before passing every quiz.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method for teaching information and verifying learning of the taught information, comprising the steps of:
providing a plurality of quizzes, each quiz of said plurality of quizzes having at least one presentation concerning a particular topic area, each one of said at least one presentation having at least one question and at least two potential answers to said at least one question;
providing a review routine that selects at least one question from said plurality of quizzes to provide a plurality of review questions;
replacing answers to said plurality of quizzes with answers to said plurality of review questions; and
checking to see if said plurality of quizzes remain passed after said review routine.

2. The method for teaching information and verifying learning of the taught information of claim 1, further comprising the step of:
retaking a failed quiz of said plurality of quizzes before proceeding to the next quiz of said plurality of quizzes.

3. The method for teaching information and verifying learning of the taught information of claim 2, further comprising the step of:
changing the order of said at least two potential answers when retaking said failed quiz.

4. The method for teaching information and verifying learning of the taught information of claim 1, further comprising the step of:
retaking said review routine after retaking said plurality of quizzes.

5. The method for teaching information and verifying learning of the taught information of claim 1, further comprising the step of:
generating a random number and choosing said at least one question from said plurality of quizzes using said random number in said review routine.

6. The method for teaching information and verifying learning of the taught information of claim 1, further comprising the step of:
utilizing a computer to implement said method of teaching information and verifying learning of the taught information.

7. A method for teaching information and verifying learning of the taught information, comprising the steps of:
providing a plurality of quizzes, each quiz of said plurality of quizzes having at least one presentation concerning a particular topic area, each one of said at least one presentation having at least one question and at least two potential answers to said at least one question;
retaking a failed quiz of said plurality of quizzes before proceeding to the next quiz of said plurality of quizzes;
providing a review routine that selects at least one question from said plurality of quizzes to provide a plurality of review questions;
replacing answers to said plurality of quizzes with answers to said plurality of review questions; and
checking to see if said plurality of quizzes remain passed after said review routine.

8. The method for teaching information and verifying learning of the taught information of claim 7, further comprising the step of:
changing the order of said at least two potential answers when retaking said failed quiz.

9. The method for teaching information and verifying learning of the taught information of claim 7, further comprising the step of:
retaking said review routine after retaking said plurality of quizzes.

10. The method for teaching information and verifying learning of the taught information of claim 7, further comprising the step of:
generating a random number and choosing said at least one question from said plurality of quizzes using said random number in said review routine.

11. The method for teaching information and verifying learning of the taught information of claim 7, further comprising the step of:
utilizing a computer to implement said method of teaching information and verifying learning of the taught information.

12. A method for teaching information and verifying learning of the taught information, comprising the steps of:
providing a plurality of quizzes, each quiz of said plurality of quizzes having at least one presentation concerning a particular topic area, each one of said at least one presentation having at least one question and at least two potential answers to said at least one question;
providing a review routine that selects at least one question from said plurality of quizzes to provide a plurality of review questions;
replacing answers to said plurality of quizzes with answers to said plurality of review questions;
checking to see if said plurality of quizzes remain passed after said review routine; and
changing the order of said at least two potential answers when retaking a failed quiz.

13. The method for teaching information and verifying learning of the taught information of claim 12, further comprising the step of:
retaking a failed quiz of said plurality of quizzes before proceeding to the next quiz of said plurality of quizzes;

14. The method for teaching information and verifying learning of the taught information of claim 12, further comprising the step of:
retaking said review routine after retaking said plurality of quizzes.

15. The method for teaching information and verifying learning of the taught information of claim 12, further comprising the step of:
generating a random number and choosing said at least one question from said plurality of quizzes using said random number in said review routine.

16. The method for teaching information and verifying learning of the taught information of claim 12, further comprising the step of:
utilizing a computer to implement said method of teaching information and verifying learning of the taught information.
